(19) United States
(12) Patent Application Publication
(10) Pub. No.: US 2007/0192845 A1
(43) Pub. Date: Aug. 16, 2007

(54) System and method for passively detecting a proxy

(75) Inventor: Carsten Michael Lankheim, San Francisco, CA (US)

Correspondence Address: Rutan & Tucker, LLP.;Hani Z. Sayed, 611 ANTON BLVD, SUITE 1400, COSTA MESA, CA, 92626, US

(73) Assignee: Xoom Corporation

(21) Appl. No.: 11/350,055

(22) Filed: Feb. 7, 2006

(51) Int. Cl. G06F 15/16

(52) U.S. Cl. 726/12

(57) ABSTRACT

The existence of a proxy can be detected by examining a timing differential between handshake messages received at a server used to establish a channel according to a first protocol and the handshake messages used to establish a secondary channel on top of the first protocol (e.g., a secure communications channel). If the time between two handshakes received at the server to set up the secondary channel is greater than the time between two handshakes received at the server to establish the initial channel, the presence of a proxy can be detected.

### TECHNICAL FIELD

The disclosed embodiments relate generally to communications between computers.

### BACKGROUND

Networks based on a layered Transmission Control Protocol over Internet Protocol (TCP/IP) model, such as the Internet, can provide for reliable communications between computers. Oftentimes these networks are organized according to the Open Systems Interconnection (OSI) model set forth by the International Standards Organization (ISO). The OSI model provides for a layered approach to network design.

The OSI model is a way of representing a network via seven layers: physical, data link, network, transport, session, presentation, and application. The physical layer provides electrical, functional, and procedural characteristics to activate, maintain, and deactivate physical links that transparently send a bit stream. The data link layer provides functional and procedural means to transfer data between network entities and correct transmission errors. The network layer determines the routing of packets of data from a sender to a receiver via the data link layer. In a TCP/IP network, the network layer uses the Internet Protocol (IP). The transport layer provides transparent and reliable transfer of data between systems. The upper layers do not need to be concerned with providing reliable and cost effective data transfer. In the TCP/IP model, the transport layer uses the Transfer Control Protocol (TCP).

Certain network services such as the File Transfer Protocol (FTP), the Hypertext Transfer Protocol (HTTP), the Secure HTTP (HTTPS), and the Simple Mail Transfer Protocol (SMTP) can be viewed as residing in one or more higher levels in the model such as level 5 through level 7. These services use the lower levels to communicate over the network. Using an interface known as a sockets interface, TCP/IP functionality can be provided to processes running on a computer. This interface provides libraries that allow for the creation of individual communications end-points called “sockets.” Each of these sockets has an associated socket address that includes a port number and the computer's network address.

Generally speaking, protocols such as TCP/IP were not designed to provide secure data transmission. Netscape Corporation developed a secure form of sockets, called the Secure Sockets Layer (SSL) protocol. The SSL protocol is layered over a transport protocol (e.g., TCP) and is comprised of two layers: the SSL Record Protocol and the SSL Handshake Protocol. The SSL Record Protocol is used for encapsulation of various higher level protocols, such as the SSL Handshake Protocol. The SSL Handshake Protocol allows two computers to authenticate each other and negotiate an encryption algorithm and cryptographic keys before the application protocol transmits or receives its first byte of data. A Transport Layer Security (TLS) protocol, while incompatible with the SSL protocol, is based on and very similar to the SSL protocol and can be used for the same purpose.

The Hypertext Transfer Protocol (HTTP) is a very common application-level protocol for distributed, collaborative, and hypermedia information systems. It is a request/response protocol that permits two computers (such as a client and a server) to exchange information. HTTP itself does not provide secure communications between computers. HTTP is widely used to access documents and/or resources within the Internet.

Between a computer requesting access to a resource (e.g., a client) and the computer hosting the resource (e.g., a server) may be one or more intermediate computers, such as a proxy. A proxy is a forwarding agent that receives requests from a client for a resource, rewrites all or part of the request message, and forwards the reformatted request toward the server identified by the request. The proxy also receives the responses to the requests and provides them to the requesting client. One common example of a proxy is a corporate firewall.

Oftentimes, such as in e-commerce applications, it is desirable to provide secure HTTP communications between a client and a server. The SSL protocol can be combined with HTTP to provide secure communications; this combination is referred to as “HTTPS”. HTTPS provides a way to permit SSL to pass through a proxy. When a client requests a connection to a secure server through a proxy, the proxy receives a request to make a connection. The proxy makes the connection using TCP. Once the connection is opened, the proxy simply tunnels the subsequent messages between the client and the server, that is it passes the messages without modification.

One area of particular concern for providers of e-commerce services is fraud. In some instances, providers are able to identify locations (e.g., from the internet protocol (IP) address) of origin that are sources of fraudulent transactions. The use of proxies, however, can mask the IP address of the originating request.

### SUMMARY

According to some embodiments, a method of inferring the presence of a proxy includes identifying a first timing statistic based on one or more first pairs of messages of a first type received from a computer. A second timing statistic is identified based on one or more second pairs of messages of a second type received from the computer and the first and second timing statistics are compared. An inference is made that the computer is a proxy in accordance with the comparison.

### BRIEF DESCRIPTION OF THE DRAWINGS

For a better understanding of the nature and embodiments of the invention, reference should be made to the Description of Embodiments below, in conjunction with the following drawings in which like reference numerals refer to corresponding parts throughout the figures.

FIG. 1 is a diagram illustrating connections between a client and a server via the use of a proxy in accordance with some embodiments of the invention.

FIG. 2 is a diagram illustrating messages between a client and a server establishing a secure communication channel using a proxy in accordance with some embodiments of the invention.

FIG. 3 is a flow chart providing a process for passively detecting the presence of a proxy in accordance with some embodiments of the invention.

FIG. 4 is a diagram illustrating messages between a requesting computer and a server which can be used to detect the presence of a proxy in accordance with some embodiments of the invention.

FIG. 5 is a block diagram of a server for implementing a process for passively inferring the presence of a proxy in accordance with some embodiments of the invention.

### DESCRIPTION OF EMBODIMENTS

According to embodiments of the invention, the existence of a proxy can be detected by examining the length of time between handshake messages of different protocols as a server. In some secure communications (e.g., HTTPS), an initial handshake protocol is used between two computers (such as between a proxy and a server). The proxy may be making a connection on behalf of a client or itself. In order to establish the connection between the proxy and the server, the proxy and the server exchange messages between themselves. If a secondary protocol (e.g., SSL) is used to establish secure communications between the client and the server on top of the previously established communication channel, the messages between them can be tunneled through the proxy. By examining a timing differential between the handshake messages used to establish the initial channel (e.g., between the proxy and the server) and the handshake messages used to establish the secure communications channel (e.g., between the server and the client) the presence of a proxy can be detected or inferred. For example, if the time between two handshakes received at the server to establish the secure communications is greater than the time between two handshakes received at the server to set up the initial channel, the presence of a proxy can be detected as described below.

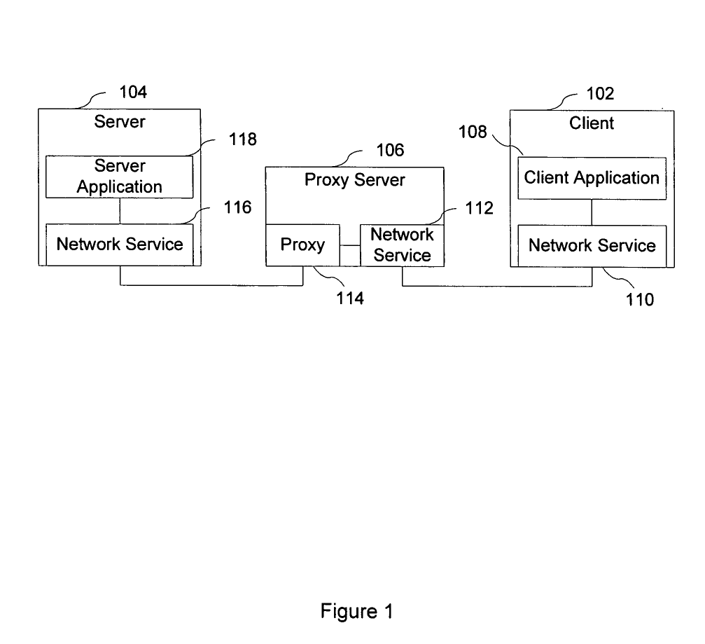

FIG. 1 is a diagram illustrating connections between a client 102 and a server 104 via the use of a proxy server 106 in accordance with some embodiments of the invention. The client 102 can include a client application 108 and a network service 110. The proxy sever 106 can include a network service 112 and a proxy 114. The server 104 can include a network service 116 and a server application 118. The client 102 can be any of a number of devices (e.g., a computer, an internet kiosk, a personal digital assistant, a cell phone, a gaming device, a desktop computer, or a laptop computer) and can include the client application 108 and the network service 110. Other applications and/or memory can be provided. The client application 108 can be a software application that permits a user to interact with the client 102 and/or network resources (e.g., server application 118) to perform one or more tasks. For example, the client application 108 can be a browser (e.g., Firefox) or other type of application that permits a user to search for, browse, and/or use resources (e.g., web pages and web services) on the client 102 and/or accessible via connection to a network (e.g., server application 118).

The communication links connecting client 102 to proxy sever 106 and/or proxy server 106 to the server 104 can be made over any local area network (LAN) and/or wide area network (WAN), such as an intranet, an extranet, the Internet or a combination of such networks. It is sufficient that the communication links provide communication capability between the client 102 and the proxy 106, and the proxy 106 and the server 104. In some embodiments, the communication links use the HyperText Transport Protocol (HTTP) to transport information using the Transmission Control Protocol/Internet Protocol (TCP/IP). HTTP permits client computers to access various local or network resources. The various embodiments of the invention, however, are not limited to the use of any particular protocol. The term “resource” as used throughout this specification refers to any piece of information or service that is accessible via a Uniform Resource Locator (URL) and can be, for example, a web page, a document, a database, an image, or a computational object.

When a client application 108 desires to securely access a resource on the server 104 (e.g., server application 118), the client application 108 initiates a request to the network service 110. When a proxy is being used, the network service 110 transmits the request for secure access to the proxy server 106. The network service 112 receives the request and uses the proxy 114 to establish the connection to the server 104. The network service 116 receives, processes, and relays information from the proxy 114 to the server application 118 and vice versa.

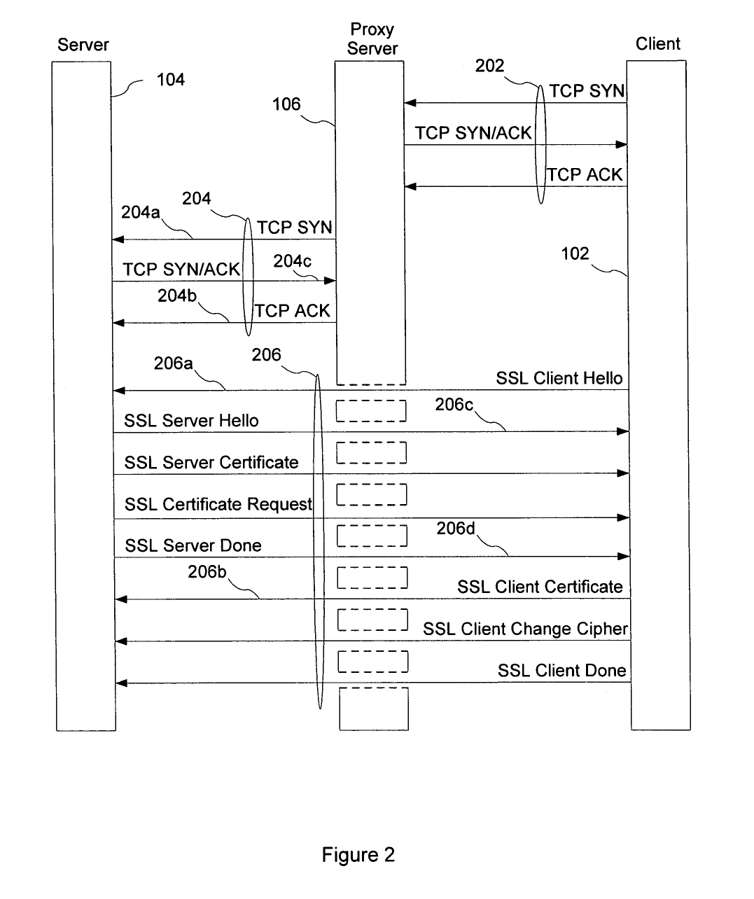

More specifically, and referring to FIG. 2, a method of using handshake messages to access a resource on a server from a client using a proxy with SSL over HTTP (e.g., HTTPS) is described. It should be noted that while the following discussion uses SSL as the exemplary security protocol, the techniques described herein apply equally well to the use of TLS over HTTP. Furthermore, the techniques described herein are not limited to the use of SSL or TLS over HTTP as will be seen below.

When an application on the client 102 (e.g., client application 108) desires to make a secure connection using SSL and HTTP to a resource on the server 104 (e.g., server application 118), the client application 108 makes a request to the network service 110. The network service 110 establishes a TCP connection to the proxy 106 using the TCP handshake messages indicated in FIG. 2 at 202. Initially a TCP SYN message is sent to the proxy server 106 to which the proxy server 106 responds with a TCP SYN/ACK message. In response to the TCP SYN/ACK message, the client 102 transmits a TCP ACK message. After the exchange of these messages, a connection is established between the client 102 and the proxy server 106. The network service 110 then sends an HTTP CONNECT request which instructs the proxy server 106 to connect to the desired computer specified in the HTTP CONNECT request. The proxy server 106 then uses the TCP handshaking protocol to establish a connection with the server 104 (as can be seen in FIG. 2 at 204). Once the connection is made, the proxy will pass information to and from the client 102 and the server 104 without modification. More detailed information regarding these connections may be found in R. Fielding, J. Gettys, J. C. Mogul, H. Frystyk, and T. Berners-Lee. Hypertext Transfer Protocol—HTTP/1.1., RFC 2068, UC Irvine, DEC, MIT/LCS, January, 1997, which is hereby incorporated by reference in its entirety.

The client 102 then begins to establish a secure communication channel using the SSL protocol. Generally speaking, the parameters of the secure communication channel are generated using the SSL Handshake Protocol. When a client and server are establishing a secure channel using SSL, they agree on a protocol version, select cryptographic algorithms, optionally authenticate each other, and use public-key encryption techniques to generate shared secrets. The following discussion highlights some features of the SSL protocol but is not intended to be exhaustive. More details regarding the SSL protocol, and TLS protocol mentioned above, may be found in, respectively, A. O. Freier, P. Karlton, Paul C. Kocher, “The SSL Protocol—Version 3.0”, draft-ietf-tls-ssl-version3-00.txt, Nov. 18, 1996 (the “SSL Reference”) and Dierks, T. and C. Allen, “The TLS Protocol”, RFC 2246, January 1999, both of which are incorporated by reference in their entirety.

With reference again to FIG. 2, messages 206 provide a typical set of handshake messages used to establish a secure channel using the SLL protocol. The messages associated with the SSL protocol are encapsulated in TCP by the various network services for transportation between the computers across the previously established TCP channels. The client 102 begins the negotiation by sending an SSL Client Hello message to the server 104. The server 104 must respond with either an alert message (indicating a failure) or an SSL Server Hello message. Prior to sending an SSL Server Done message 206d to the client 102, the server 104 may send zero or more additional messages as described below. The client 102 waits to send any message to the server 104 until receiving an SSL Server Done message 206d (except in the case where an SSL Server Hello Request is received). Note that the SSL messages are shown in FIG. 2 as passing through the proxy server 106 through dotted line tunnels indicating that the messages are passed through (i.e., received and retransmitted by) the proxy server 106 unmodified.

The SSL Client Hello message 206a and the SSL Server Hello message 206c are used to establish security capabilities between the client 102 and the server 104 as described in the above-mentioned SSL Reference. Following the SSL Server Hello message, but prior to an SSL Server Done message, the server 104 may send zero or more additional messages. For example, the server 104 may send its certificate in an SSL Server Certificate message. The server 104 may also send an SSL Certificate Request which is used to request a certificate from the client 102. The server may also send an SSL Server Key Exchange message (not shown) when certain conditions are satisfied. After the desired zero or more additional messages are sent, the server 104 sends an SSL Server Done message, indicating that the hello-message phase of the handshaking is complete. The server 104 then waits for a response from the client 102.

The first message that the client 102 may send after receiving an SSL Server Done message is an SSL Client Certificate 206b which provides the server 104 with the certificate of the client 102, if one was requested. The client 102 may send a client key exchange message depending upon a selected public key algorithm. The client 102 may also send a certificate verify message (not shown) used to explicitly verify the client certificate when the client certificate has signing authority. The client 102 sends an SSL Client Change Cipher message indicating to the server 104 to initiate communications based on the just-negotiated parameters. After the client 102 sends the SSL Client Change Cipher message, subsequent messages in this channel between the client 102 and the server 104 use the just-negotiated security parameters. An SSL Client Done message is sent immediately after the SSL Client Change Cipher message and is sent using the just-negotiated parameters. At this point, the handshaking is complete and the client 102 and server 104 may exchange application layer data.

In the two protocol handshake types described above (e.g., the TCP handshaking 204 and the SSL handshaking 206) a round trip exchange of information is required from the originator of the connection request to the receiver of the connection request and then back to the originator. In the case of the TCP handshaking 204, the relevant handshakes are between the proxy server 106 and the server 104, whereas, in the case of the SSL handshaking 206, the SSL handshakes are between the client 102 and the server 104; the proxy 106 does not participate in the SSL handshaking except for passing through the messages. The presence of a proxy can be detected by comparing a time between messages of the TCP handshakes to a time between messages of the SSL handshakes.

In some embodiments of the invention, a handshake time is determined for the TCP handshake and for the SSL handshake. The two times are compared and various techniques can be used to make a proxy inference (i.e., a determination of whether there is a proxy in the client-server communication path). For example, when the difference between the handshake times is greater than a threshold, the presence of a proxy is inferred (i.e., detected). In another example, a ratio of the handshake times is used to detect a proxy. When the ratio of the SSL handshake time to the TCP handshake time is greater than a threshold, the presence of a proxy is detected.

In some embodiments, the server 104 can store handshake times gathered from multiple requests from the same requestor for both TCP handshakes and SSL handshakes and build various statistical models. The server 104 can make various conclusions based on, for example, a mean, a minimum, a maximum, and a standard deviation for the respective handshake times.

The TCP handshake time can be determined, for example, by noting the time that the TCP SYN message was received at the server 104 (e.g., the time when message 204a was received) and the time when the TCP ACK message was received (e.g., the time when message 204b was received). The difference in the two times can represent the total handshake time for the TCP connection. Alternatively, the time that the server 104 sends the TCP SYN/ACK message could be noted. In this instance, the TCP handshake time can be represented by the elapsed time between the TCP SYN/ACK message (e.g., message 204c) and the TCP SYN message (e.g., message 204b). It is sufficient that the TCP handshake time be representative of a time a message travels to the server 104 from the handshake originator, or an approximate multiple thereof.

The SSL handshake time can be determined, for example, by parsing the SSL structures received and transmitted during the negotiation process 206. For example, a handshake time can be identified as the elapsed time between an SSL Client Hello message (e.g., message 206a) and an SSL Client Certificate message (e.g., message 206b). Alternatively, the handshake time can be identified as the elapsed time between an SSL Server Hello message (e.g., message 206c) and an SSL Client Certificate message (e.g., message 206b). In another alternative, the handshake time can be identified as the elapsed time between an SSL Server Done message (e.g., message 206d) and an SSL Client Certificate message (e.g., 206b). Unlike the TCP handshaking, the SSL handshaking may include additional handshake messages depending on the circumstances (e.g., an SSL Certificate Request sent to the client 102). In some embodiments, other messages can be used to representatively identify an SSL handshake time. It is sufficient that the SSL handshake time be representative of a time a message travels to the server 104 from the handshake originator, or an approximate multiple thereof. In one embodiment, because the SSL handshake messages are sent and received in TCP packets, the SSL handshake time can be identified as the elapsed time between the first pair of received TCP packets after the establishment of a TCP connection between which the server 104 sent at least one TCP packet. In this embodiment, the SSL structures need not be parsed, which results in some ease of computation.

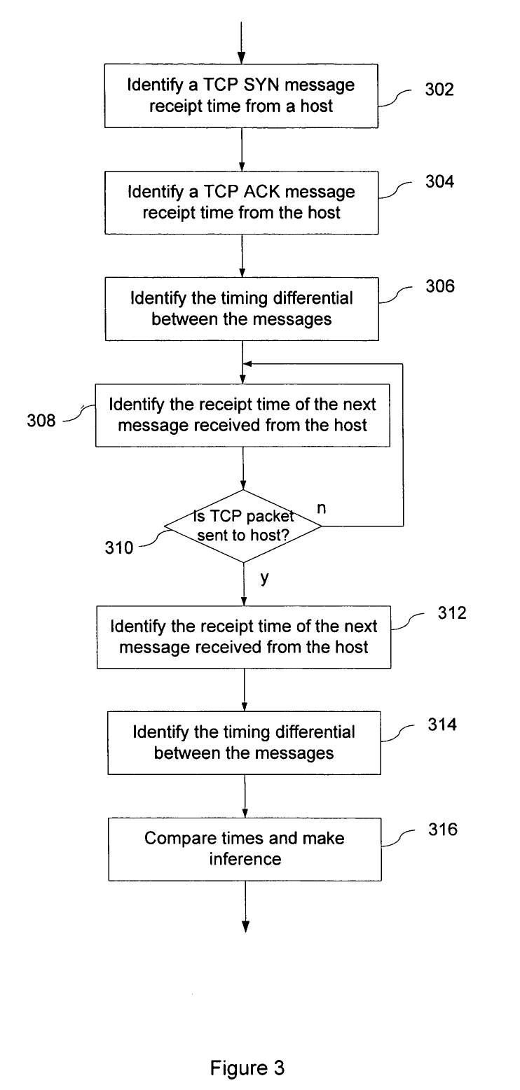

FIG. 3 provides a flow chart providing a process for passively detecting the presence of a proxy in accordance with some embodiments of the invention. Initially, a TCP SYN message is identified from a host and the receipt time is noted (302). When the host receives a TCP ACK message, the receipt time for this message is noted (304). A timing differential is identified between the two messages (306). For example, an elapsed time between the messages can be determined. The server 104 then identifies a receipt time of the next TCP message received from the host (308). If the server 104 does not send a TCP packet (310-n) then the process returns to identifying a receipt time of the next TCP message received from the host (308). If, on the other hand the server 104 responded to a TCP message by sending a TCP packet (310-y), then the receipt time of the a TCP message from the host after the transmitted TCP packet is identified and the time noted (312). These TCP messages can include the SSL handshake messages encapsulated in the TCP packets as described above. A timing differential between the messages of 308 and 312 is then identified (314). The first timing differential determined at 306 and the timing differential determined at 314 are then compared (316). If the difference between the timing differential is considered significant then a proxy is detected. For example, when the timing differential determined at 314 is greater than the timing differential determined at 306 by a threshold amount, then a proxy is detected. As mentioned above, multiple pairs of TCP receipt messages can be examined and statistical methods used to evaluate the timing differentials. For example, multiple TCP initiation handshakes can be accumulated and analyzed to better identify the TCP handshake time to the TCP requestor. Likewise, multiple SSL handshake times can be analyzed to detect the presence of a proxy with higher confidence over time. While FIG. 3 shows the stages in a particular order, it is not intended to limit the order of the stages unduly. In other embodiments, the stages may be differently ordered. For example, the stage 306 could occur subsequent to, or in parallel with, stage 312. One of ordinary skill in the art would recognize various ways to reorder the stages.

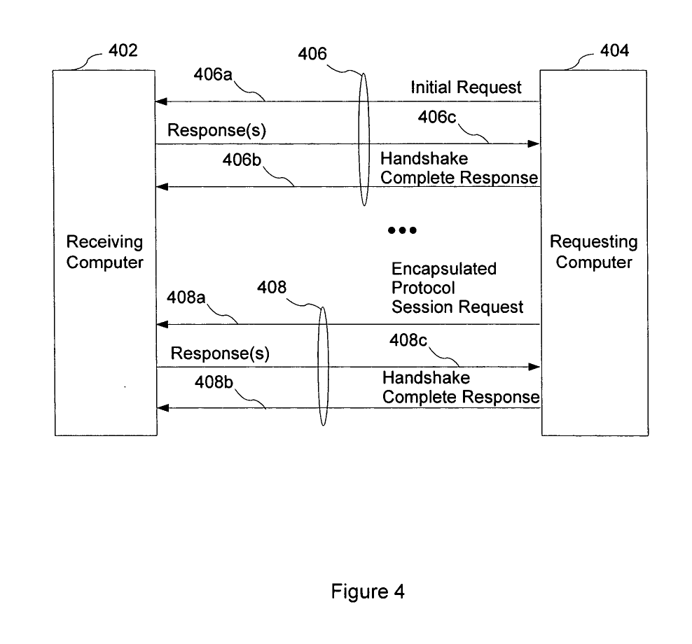

FIG. 4 provides a more generalized technique for detecting the presence of a proxy. A receiving computer 402 receives requests from a requesting computer 404 to establish connections based on multiple handshaking protocols, for example a first and a second protocol, where the second protocol is encapsulated by the first protocol. The first protocol can be a transport protocol (e.g., TCP) where a connection is established between the requesting computer 404 and the receiving computer 402 based on handshakes between the two computers. The second protocol can be layered over, or encapsulated by, the first protocol such that handshaking to establish a communication channel according to the second protocol occurs between the originating computer that begins the handshake and the receiving computer 402 (e.g., SSL over TCP). The second protocol can be a protocol that can be tunneled. Referring to FIG. 4, the first handshakes 406 proceed according to the transport protocol. The second handshakes 408 proceed according to the encapsulated protocol. When a request to establish a connection according to the encapsulated protocol originates from a computer different from the requesting computer 404, the time required to complete the handshake protocol is likely to be significantly greater than the time required to complete the handshake for the first protocol. The time for the first handshake completion can be determined by, for example, determining an elapsed time from an initial request message 406a to a handshake complete response 406b. One or more responses 406c can be transmitted to the requesting computer 404 as part of the handshaking. In some embodiments, an elapsed time is not determined unless at least one response message is transmitted to the requesting computer 404 after the receiving computer 402 receives the initial request message 406a. Alternatively, an elapsed time can be measured from a response 406c until the handshake complete response 406b is received. Although the example above uses a handshake complete response 408b, other responses generated from the originating requestor can be used. It is sufficient that the handshakes used to create the timing differential result in a representative time for messages to travel to the server 104 from the handshake originator, or an approximate multiple thereof.

The time for the second, or encapsulated, handshake completion can be determined by, for example, determining an elapsed time from an initial encapsulated session request message 408a to a handshake complete response 408b. One or more responses 408c can be transmitted to the requesting computer 404 as part of the handshaking. However, because the second protocol uses handshaking with the originating requester, these responses 408c are forwarded to the originating requestor. In some embodiments, an elapsed time is not determined unless at least one response message 408c is transmitted to the requesting computer 404 after the receiving computer 402 receives the initial encapsulated session request message 408a. Alternatively, an elapsed time can be measured from a response 408c until the handshake complete response 408b is received. Although the example above uses a handshake complete response 408b, other responses generated from the originating requestor can be used.

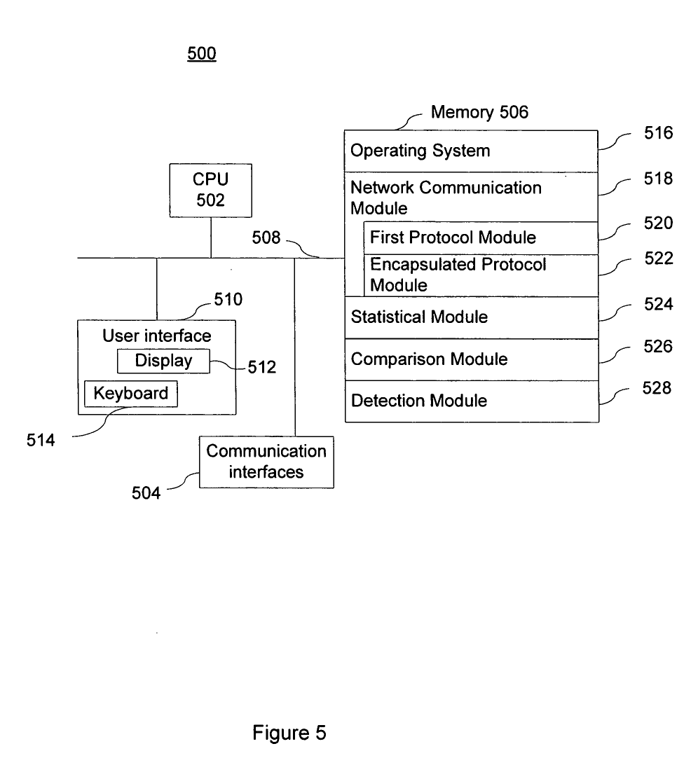

FIG. 5 is a block diagram illustrating a server 500 in accordance with an embodiment of the present invention. The server 500 typically includes one or more processing units (CPUs) 502, one or more network or other communications interfaces 504, memory 506, and one or more communication buses 508 for interconnecting these components. The server 500 optionally may include a user interface 510 comprising a display device 512 and a keyboard 514. Memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 506 may optionally include one or more storage devices remotely located from the CPU(s) 502. In some embodiments, memory 506 stores the following programs, modules and data structures, or a subset thereof:
an operating system 516 that includes procedures for handling various basic system services and for performing hardware dependent tasks;
a network communication module 518 that is used for connecting the server 500 to other computers via the one or more communication network interfaces 504 and one or more communication networks, such as the Internet, other wide area networks, local area networks, metropolitan area networks, and so on, including a transport protocol module 520 (or instructions) for receiving, processing, and transmitting messages according to a first protocol, and an encapsulated protocol module 522 (or instructions) for receiving, processing, and transmitting message according to an encapsulated protocol;
a statistical module 524 (or instructions) for creating and maintaining timing statistics and values associated with the various handshake messages of various protocols (e.g., the first protocol and the encapsulated protocol);
a comparison module 526 (or instructions) for comparing the timing statistics; and
an detection module 528 (or instructions) for detecting the presence of a proxy in accordance with information generated from the comparison module 526.

Each of the above identified elements in FIG. 5 can be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, the memory 506 may store a subset of the modules and data structures identified above. Furthermore, the memory 506 may store additional modules and data structures not described above.

Although FIG. 5 shows a server 500, the figure is intended more as functional description of the various features which may be present in a server than as a structural schematic of the embodiments described herein. In practice, and as recognized by those of ordinary skill in the art, items shown separately could be combined and some items could be separated. For example, some items shown separately in FIG. 5 could be implemented on single servers and single items could be implemented by one or more servers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of inferring the presence of a proxy, comprising:
identifying a first timing statistic based on a first pair of messages of a first type received from a computer;
identifying a second timing statistic based on a second pair of messages of a second type received from the computer;
comparing the first and second timing statistics; and
making an inference that the computer is a proxy in accordance with the comparison.

2. The method of claim 1, wherein the first pair of messages relate to a first protocol and the second pair of messages relate to a second protocol.

3. The method of claim 1, wherein the first pair of messages comprise handshake messages using a first protocol and the second pair of messages comprise handshake messages using a second protocol.

4. The method of claim 1, wherein the second type is an encapsulated protocol.

5. The method of claim 1, wherein the first timing statistic is based on a timing difference between the first pair and the second timing statistic is based on a timing difference between the second pair.

6. The method of claim 1, wherein the inference is made when the second timing statistic is greater than the first timing statistic.

7. The method of claim 1, wherein the inference is made when the second timing statistic is greater than the first timing statistic by at least a threshold amount.

8. A computer program product for use in conjunction with a computer system, the computer program product comprising a computer readable storage medium and a computer program mechanism embedded therein, the computer program mechanism comprising:
instructions for identifying a first timing statistic based on a first pair of messages of a first type received from a computer;
identifying a second timing statistic based on a second pairs of messages of a second type received from the computer;
comparing the first and second timing statistics; and
making an inference that the computer is a proxy in accordance with the comparison.

9. A system for presenting information, comprising:
a main memory;
a processor; and
a program, stored in the main memory and executed by the processor, the program including instructions for identifying a first timing statistic based on a first pair of messages of a first type received from a computer;
identifying a second timing statistic based on a second pair of messages of a second type received from the computer;
comparing the first and second timing statistics; and
making an inference that the computer is a proxy in accordance with the comparison.

10. A system for presenting information, comprising:
means for identifying a first timing statistic based on a first pair of messages of a first type received from a computer;
means for identifying a second timing statistic based on a second pair of messages of a second type received from the computer;
means for comparing the first and second timing statistics; and
means for making an inference that the computer is a proxy in accordance with the comparison.

11. A method of detecting the presence of a proxy in a communication path, comprising:
identifying a first timing statistic based on a first pair of messages received from a communication path;
identifying a second timing statistic based on a second pair of messages of a second type received from the communication path;
comparing the first and second timing statistics; and
detecting the presence of a proxy in the communication path based on the comparison.
